(19) United States
(12) Patent Application Publication
(10) Pub. No.: US 2013/0341321 A1
(43) Pub. Date: Dec. 26, 2013

(54) Microwave Based System for Radiantly Heating an Area

(71) Applicant: Wavetech International, Putnum, CT (US)

(72) Inventor: Thomas Munroe, Oneco, CT (US)

(21) Appl. No.: 13/922,993

(22) Filed: Jun. 20, 2013

Related U.S. Application Data
(60) Provisional application No. 61/662,056, filed on Jun. 20, 2012.

(51) Int. Cl. H05B 6/80

(52) U.S. Cl. CPC H05B 6/804
USPC 219/688

(57) ABSTRACT

A microwave based radiant heating system is provided and includes a microwave heating system having a heating cavity and a radiant pipe system having a pipe heating portion, wherein pipe heating portion is located within the heating cavity and wherein the radiant pipe system contains a fluid having a predictable thermal storage capability. Additionally, a fluid pump in flow communication with the radiant pipe system is provided, wherein the fluid pump is configured to cause the fluid to flow within the radiant pipe system and the pipe heating portion.

### RELATED APPLICATIONS

This application claims priority to and benefit of the filing date of U.S. Provisional Patent Application Ser. No. 61/662,056 (Atty. Docket No. REN-0001-P), filed Jun. 20, 2012, the contents of which are incorporated by reference herein in its entirety.

### FIELD OF THE INVENTION

The present invention relates generally to a radiant heating system for a building and more particularly to a microwave based radiant heating system for a building.

### BACKGROUND OF THE INVENTION

As the world's population increases, so too does the energy necessary to carry on day to day activities. For example, cities, towns and businesses need to have electricity to operate its machinery and lighting. Additionally, automobiles, trucks and aircraft need to have fuel to transport people and goods to their required destination. This need for energy is even more necessary in cooler climates where the people depend on heat for survival. Unfortunately, this increased energy consumption has several undesirable consequences. One such consequence involves the use of traditional combustible fuel resources, such as coal, oil and natural gas. This process of burning this fuel generates pollutants that are released into the air and that have a deleterious effect on both people and the environment. For example, the burning of fossil fuels generates greenhouse gases, such as carbon dioxide, which build up in the upper portion of the atmosphere. When sunlight is incident on the earth, these gases allow the sunlight to enter the atmosphere freely. The sunlight strikes the earths' surface where some of it is reflected back towards space as infrared radiation (i.e. heat). This infrared radiation is then absorbed and trapped by the greenhouse gases that have built up in the atmosphere, thus causing an increase in global temperatures.

Another consequence involves the amount of fuel being used to demand for increased energy. As mentioned above, fossil fuels are used to generate the energy required by the majority of the world's population. However, because resources are non-renewable with finite global reserves, once these reserves have been depleted alternative sources of energy must be found. Additionally, as these resources become more scarce the cost of locating, mining and processing these fuels increases. This is undesirable because these costs are passed onto the consumer. This issue can be solved by either finding a new, plentiful and renewable source of energy or by conserving the resources that we have. One way to conserve these resources is to make the most efficient use of the energy that is being generated.

### SUMMARY OF THE INVENTION

A microwave based radiant heating system is provided and includes a microwave heating system having a heating cavity and a radiant pipe system having a pipe heating portion, wherein pipe heating portion is located within the heating cavity and wherein the radiant pipe system contains a fluid having a predictable thermal storage capability. Additionally, a fluid pump in flow communication with the radiant pipe system is provided, wherein the fluid pump is configured to cause the fluid to flow within the radiant pipe system and the pipe heating portion.

A microwave based radiant heating system is provided and includes a microwave heating system having a heating cavity, a pipe system having a pipe heating portion, wherein pipe heating portion is located within the heating cavity, a fluid, wherein the fluid is capable of retaining heat in a predictable fashion, a fluid pump in flow communication with the pipe system to controllably cause the fluid to flow within the pipe system and the pipe heating portion and a control system in communication with at least one of the microwave heating system and the fluid pump, wherein the control system is configured to control at least one of the microwave heating system and the fluid pump.

A method for heating an area using a microwave based radiant heating system, wherein the microwave heating system includes a heating cavity, a pipe system having a fluid heating portion, wherein fluid heating portion is located within the heating cavity, a fluid, wherein the fluid is capable of retaining heat in a predictable fashion, a fluid pump in flow communication with the pipe system to controllably cause the fluid to flow within the pipe system and the fluid heating portion and a control system in communication with at least one of the microwave heating system and the fluid pump, wherein the control system is configured to control at least one of the microwave heating system and the fluid pump is provided. The method includes sensing a temperature in at least one area, wherein the at least one area is heated using the microwave based radiant heating system, operating the microwave heating system to generate heated fluid, wherein the microwave heating system is operated at least partially responsive to the sensed temperature to cause the fluid within the fluid heating portion to heat up and operating the fluid pump to cause the heated fluid to flow through the pipe system to heat the at least one area.

### BRIEF DESCRIPTION OF THE DRAWINGS

The foregoing and other features and advantages of the present invention should be more fully understood from the accompanying detailed description of illustrative embodiments taken in conjunction with the following Figures in which like elements are numbered alike in the several Figures:

FIG. 1 is a schematic block diagram of a microwave based radiant heating system, in accordance with an exemplary embodiment of the present invention.

FIG. 2A is an exploded side view of a microwave heating system of the microwave based radiant heating system of FIG. 1, illustrating thermal change in the fluid.

FIG. 2B is a schematic block diagram of the microwave based radiant heating system of FIG. 1, illustrating thermal change in the fluid.

FIG. 3 is a schematic block diagram of a microwave based radiant heating system illustrating thermal change in the fluid, in accordance with an additional embodiment of the present invention.

FIG. 4 is a schematic block diagram of a microwave based radiant heating system illustrating thermal change in the fluid, in accordance with an additional embodiment of the present invention.

FIG. 5 is a schematic block diagram of a microwave based radiant heating system, in accordance with still yet another embodiment of the present invention.

### DETAILED DESCRIPTION OF THE INVENTION

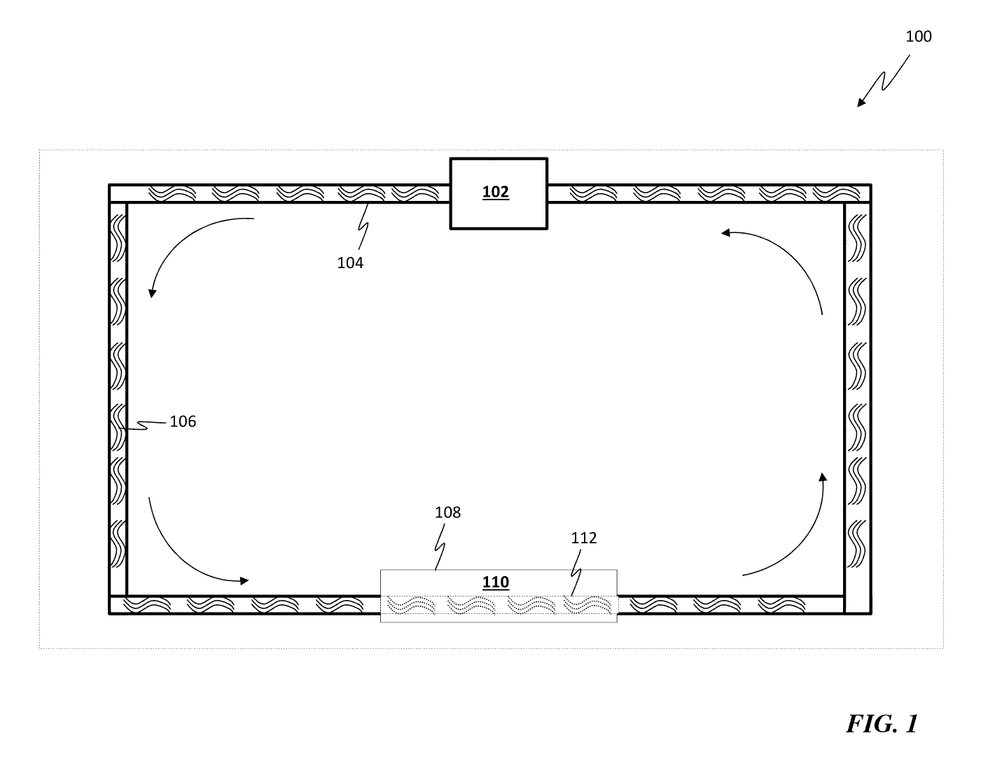

Referring to FIG. 1, a microwave based radiant heating system 100 is provided, in accordance with one embodiment of the present invention and includes a fluid pump 102 in flow communication with a closed loop pipe system 104 containing a fluid 106 and at least one microwave heating system 108 having a heating cavity 110, wherein a pipe portion 112 of the closed loop pipe system 104 is configured to be within the heating cavity 110 of the microwave heating system 108 such that the pipe portion 110 and the fluid 106 flowing within the pipe portion 110 is exposed to microwave energy generated by the microwave heating system 108.

In accordance with the present invention, the fluid pump 102 is operated to cause the fluid 106 to flow within the closed loop pipe system 104. As the fluid 106 flows into the pipe portion 112, the microwave heating system 108 is operated to generate microwave energy that is directed into the heating cavity 110. It should be appreciated that as the microwave energy interacts with the molecules of the fluid 106, the molecules ‘vibrate’ causing the fluid 106 within the heating cavity 110 to heat up. The fluid 106 contained within the heating cavity 110 will be heated by the microwave energy being directed therein. When the fluid 106 flows out of the pipe portion 112, the fluid 106 has a higher thermal temperature than the fluid 106 had when it flowed into the pipe portion 112.

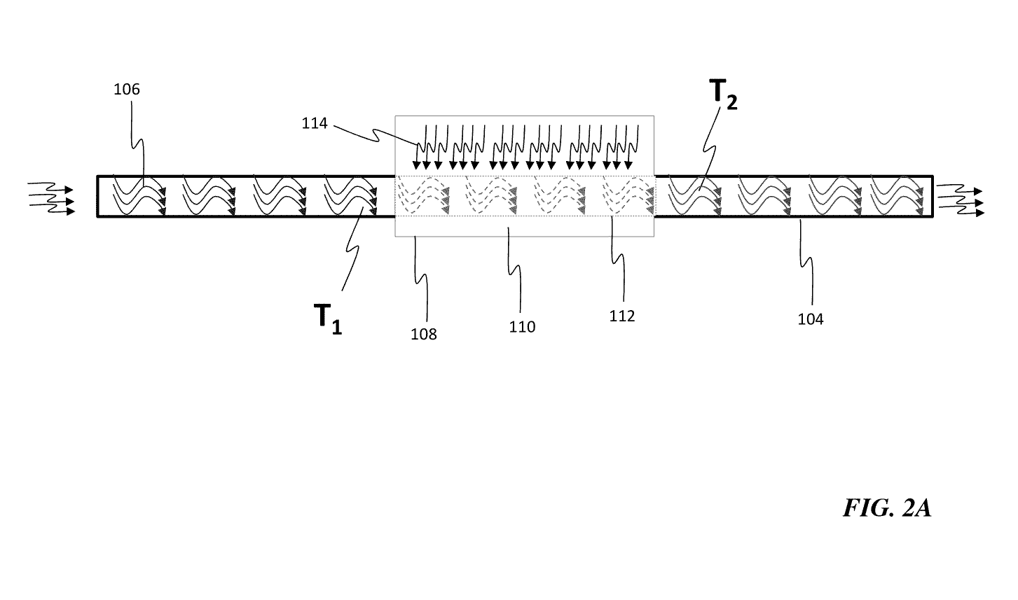

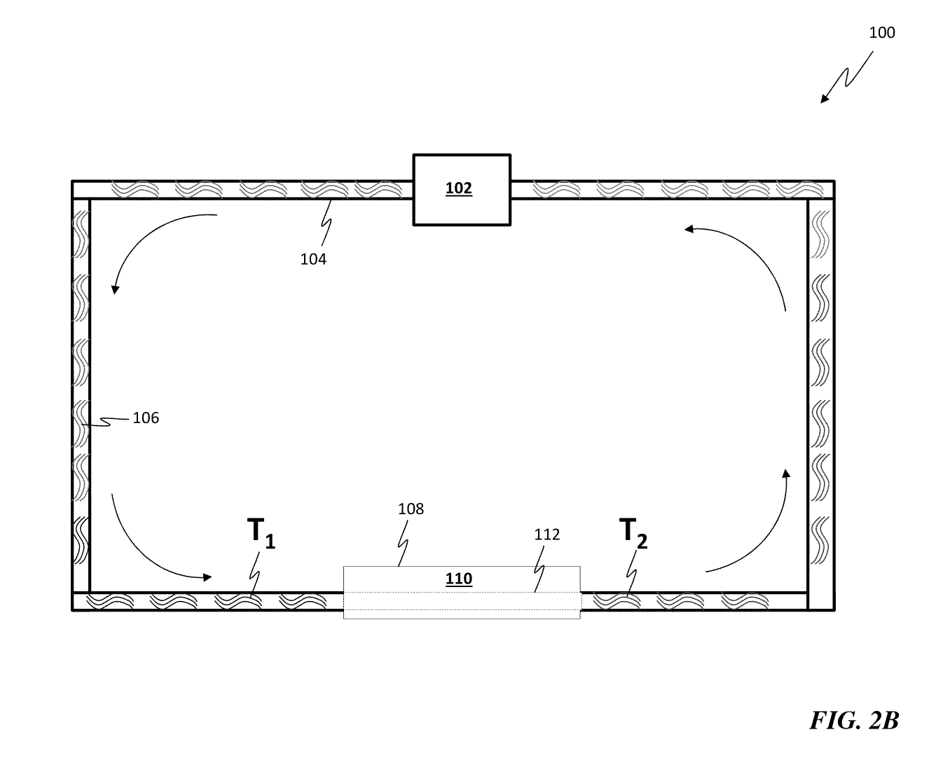

This can be better seen by referring to FIG. 2A, where reference is made to a specific amount of fluid 106. As can be seen, a fluid 106 flowing into the heating cavity 110 has a first fluid temperature T₁ (shown in blue). As the fluid 106 enters and flows through the heating cavity 110, microwave energy 114 becomes incident upon the flowing fluid 106 causing the fluid 106 to heat up (shown in green) as it flows through the heating cavity 110. By the time the fluid 106 exits the heating cavity 110, the fluid has a second fluid temperature T₂ (shown in red), where the first fluid temperature T₁ is lower than the second fluid temperature T₂. This heated fluid 106 is then distributed throughout the closed loop pipe system 104 where the heat is radiated to the environment. It should be appreciated that as the fluid 106 flows through the closed loop pipe system 104, the temperature of the heated fluid 106 begins to drop and eventually the temperature of the fluid 106 drops from the second fluid temperature T₂ to the lower first fluid temperature T₁. This can be seen in FIG. 2B where the second fluid temperature T₂ is shown decreasing to the lower first fluid temperature T₁. As this is a closed loop system, the cooled fluid 106 having a first fluid temperature T₁ then flows back into the heating cavity 110 and reheated to the second fluid temperature T₂ and then flows back out to the system 104.

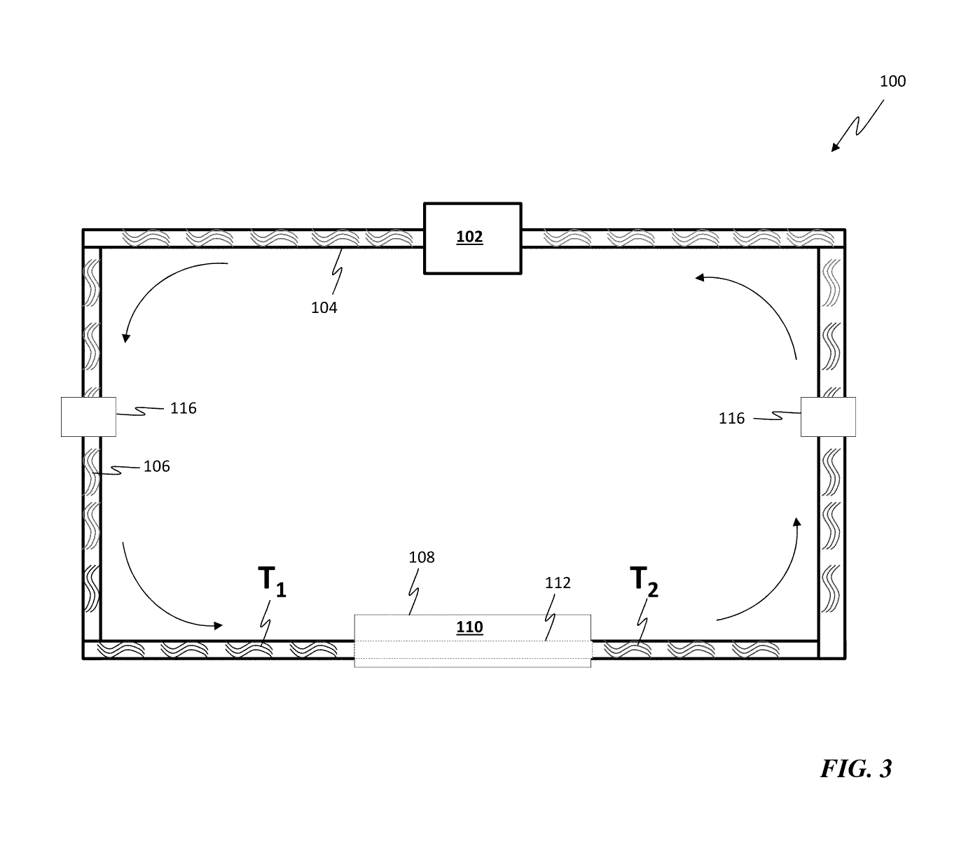

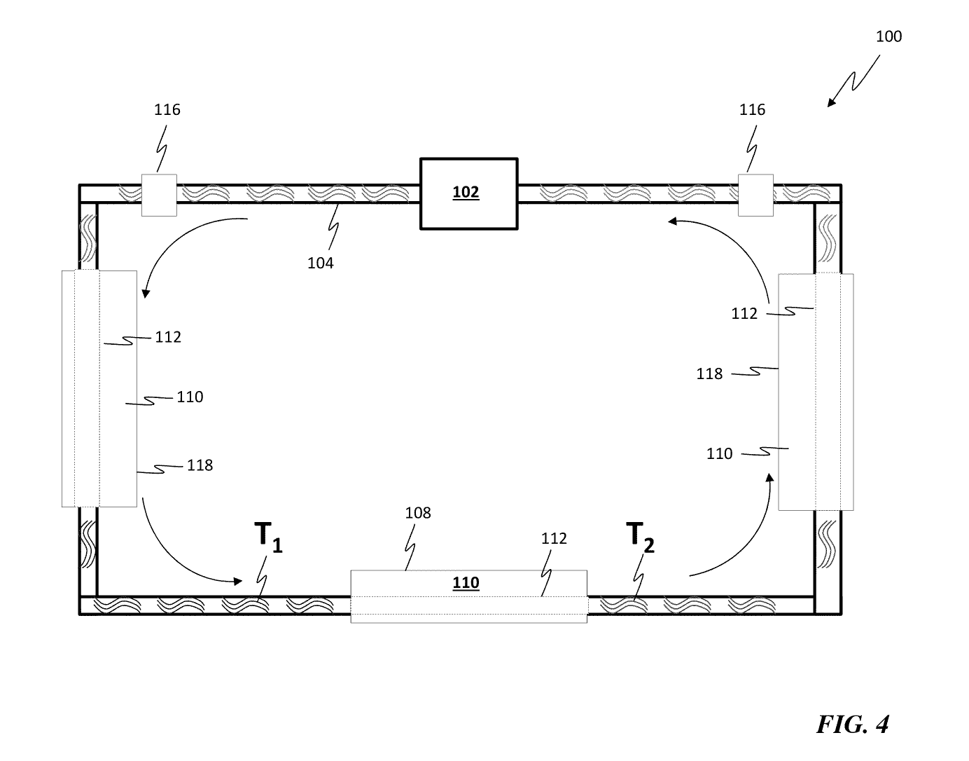

Referring to FIG. 3, it should be appreciated that the microwave based radiant heating system 100 may include one or more fluid temperature sensors 116 to sense the temperature of the fluid 106 contained within the closed loop pipe system 104. The one or more fluid temperature sensors 116 may then communicate the fluid temperature to the microwave heating system 108 which may then control the microwave energy being directed into the heating cavity 110. This would allow the microwave based radiant heating system 100 to make the fluid 106 contained therein either hotter or cooler. Additionally, referring to FIG. 4 additional heating cavities 118 may be included throughout the system to help maintain the thermal level of the fluid 106.

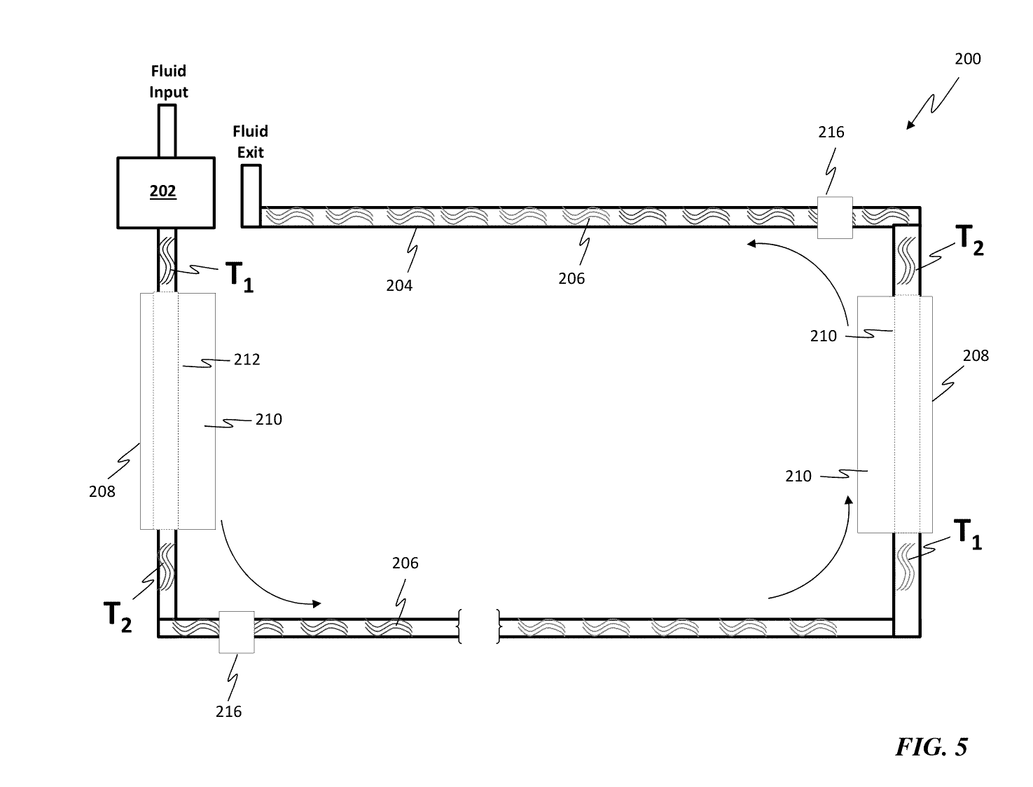

Referring to FIG. 5, a microwave based radiant heating system 200 is provided in accordance with another embodiment of the present invention and includes a fluid pump 202 in flow communication with an open loop pipe system 204 containing a fluid 206 and at least one microwave heating system 208 having a heating cavity 210, wherein a pipe portion 212 of the open loop pipe system 204 is configured to be within the heating cavity 210 of the microwave heating system 208 such that the pipe portion 210 and the fluid 206 flowing within the pipe portion 210 is exposed to microwave energy generated by the microwave heating system 208.

It should be appreciated that the microwave based radiant heating system 200 may include one or more fluid temperature sensors 216 to sense the temperature of the fluid 206 contained within the open loop pipe system 204. The one or more fluid temperature sensors 216 may then communicate the fluid temperature to the microwave heating systems 208 which may then control the microwave energy being directed into the heating cavity 210. This would allow the microwave based radiant heating system 200 to make the fluid 206 contained therein either hotter or cooler as needed.

A method for heating an area using a microwave based radiant heating system, wherein the microwave heating system includes a heating cavity, a pipe system having a fluid heating portion, wherein fluid heating portion is located within the heating cavity, a fluid, wherein the fluid is capable of retaining heat in a predictable fashion, a fluid pump in flow communication with the pipe system to controllably cause the fluid to flow within the pipe system and the fluid heating portion and a control system in communication with at least one of the microwave heating system and the fluid pump, wherein the control system is configured to control at least one of the microwave heating system and the fluid pump is provided. The method includes sensing a temperature in at least one area, wherein the at least one area is heated using the microwave based radiant heating system, operating the microwave heating system to generate heated fluid, wherein the microwave heating system is operated at least partially responsive to the sensed temperature to cause the fluid within the fluid heating portion to heat up and operating the fluid pump to cause the heated fluid to flow through the pipe system to heat the at least one area.

In accordance with the present invention, the closed loop pipe system 104 and the open loop pipe system 204 of the present invention may include composite, rubber, metal or plastic pipes, as desired. However, the pipe portion 112, 212 are preferably constructed from a material that is compatible with microwave systems. It should be appreciated that the microwave based radiant heating system 100, 200 may include a control system that periodically or continuously senses the temperature of the fluid within the pipe system 104, 204 and/or the environment in predetermined zones associated with the microwave based radiant heating system 100, 200. The control system may then control the fluid pump 102, 202 and the at least one microwave heating system 108, 208 based, at least in part, on the sensed temperatures. It should also be appreciated that the fluid 106 used for the closed loop system may be water or other type of fluid suitable to the desired end purpose, while fluid used for the open loop system 202 may be water.

It is contemplated that the invention may be implemented via manual switches (analog/digital), or the invention may be implemented via software. Also, the user interface could allow for programming any routing configuration via other switch means (e.g. alternate switches which control effect sequence with dedicated visual indicators for each effect's position in the routing sequence). Moreover, in other embodiments features may or may not be included as desired. Also, the parallel mix bus could be excluded or limited to certain effects. There are various methods that could be used for implementing the routing in the invention, including but not limited to mechanical switches (including relays), solid state switches, and multiplexing integrated circuits. Moreover, the attached appendices are not intended and should not be viewed as limiting the invention. Rather, the information contained within the appendices should be viewed as augmenting the scope of the invention and any information that appears to be inconsistent should be viewed as an additional embodiment and/or as an addition to an existing embodiment.

In accordance with the present invention, the processing of the invention may be implemented, wholly or partially, by a controller operating in response to a machine-readable computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing.

It should be appreciated that while the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A microwave based radiant heating system, comprising,
a microwave heating system having a heating cavity;
a pipe system having a fluid heating portion, wherein fluid heating portion is located within the heating cavity;
a fluid, wherein the fluid is capable of retaining heat in a predictable fashion;
a fluid pump in flow communication with the pipe system to controllably cause the fluid to flow within the pipe system and the fluid heating portion; and
a control system in communication with at least one of the microwave heating system and the fluid pump, wherein the control system is configured to control at least one of the microwave heating system and the fluid pump.

2. The microwave based radiant heating system of claim 1, further comprising at least one temperature sensing device located in at least one area which is heated using the pipe system, wherein the at least one temperature sensing device senses the temperature in the at least one area.

3. The microwave based radiant heating system of claim 2, wherein the at least one temperature sensing device is communicated with the control system and is configured to communicate the temperature to the control system.

4. The microwave based radiant heating system of claim 3, wherein the control system controls at least one of the microwave heating system and the fluid pump responsive to the temperature sensed in the at least one area such that fluid contained within the fluid heating portion is heated and caused to flow through the pipe system.

5. A method for heating an area using a microwave based radiant heating system, wherein the microwave heating system includes a heating cavity, a pipe system having a fluid heating portion, wherein fluid heating portion is located within the heating cavity, a fluid, wherein the fluid is capable of retaining heat in a predictable fashion, a fluid pump in flow communication with the pipe system to controllably cause the fluid to flow within the pipe system and the fluid heating portion and a control system in communication with at least one of the microwave heating system and the fluid pump, wherein the control system is configured to control at least one of the microwave heating system and the fluid pump, the method comprising:
sensing a temperature in at least one area, wherein the at least one area is heated using the microwave based radiant heating system;
operating the microwave heating system to generate heated fluid, wherein the microwave heating system is operated at least partially responsive to the sensed temperature to cause the fluid within the fluid heating portion to heat up; and
operating the fluid pump to cause the heated fluid to flow through the pipe system to heat the at least one area.

6. The method of claim 5, wherein the fluid pump is configured to adjustably control the velocity of the fluid flowing through the pipe system.

7. The method of claim 5, wherein the microwave heating system is configured to adjustably control the microwave energy being used to heat the fluid.
